(19) United States
(12) Patent Application Publication
(10) Pub. No.: US 2010/0227021 A1
(43) Pub. Date: Sep. 9, 2010

(54) DEER FOOD FORMULATIONS AND RELATED METHODS

(75) Inventor: Doug Arnold, Florissant, CO (US)

Correspondence Address: MACMILLAN SOBANSKI & TODD, LLC, ONE MARITIME PLAZA FIFTH FLOOR, 720 WATER STREET, TOLEDO, OH, 43604-1619, US

(73) Assignee: WOODLAND OUTDOOR GROUP, LLC, Sparta, NJ (US)

(21) Appl. No.: 12/718,062

(22) Filed: Mar. 5, 2010

Related U.S. Application Data
(60) Provisional application No. 61/157,994, filed on Mar. 6, 2009.

(51) Int. Cl. A23K 1/18; A23K 1/16; A23K 1/20

(52) U.S. Cl. 426/2; 426/648; 426/73; 426/285

(57) ABSTRACT

Deer food formulations, methods and uses are provided. In particular, protein, fiber, mineral and other optimization, for increasing deer health and physiology are provided. Methods to make the deer food are also provided.

### STATEMENT REGARDING RELATED APPLICATIONS

This application claims the benefit of U.S. Provisional Application Ser. No. 61/157,994, filed Mar. 6, 2009, the entire disclosure of which is expressly incorporated herein by reference.

### STATEMENT REGARDING FEDERALLY SPONSORED RESEARCH

No federal funding was used in developing this invention.

### TECHNICAL FIELD

This invention relates generally to deer food formulations. In particular, the invention relates to foods useful to feed animals of the phylogenic family cervidae, especially the subfamily capreolinae, most especially the genus odocoileus. While the invention could theoretically be useful for advantageously feeding any even-toed ungulate, the most commonly hunted are the white-tailed deer, black tail deer, mule deer, caribou, reindeer, elk and moose. The formulations and methods herein are particularly useful in that they resist water absorption.

### BACKGROUND OF THE INVENTION

While the concept of feeding wild birds is a widely-accepted practice, feeding wild deer has been largely limited to hunters. Retailers, such as Cabela's, offer several brands of deer feeds. The majority of such feeds purport to cause “trophy” antler growth. Others purport to lure animals by using high levels of sweeteners. A few products indicate that protein is part of the formula. In addition, modified salt licks, packages of seed for growing deer-attracting plants, and chemical attractants are available to nurture antler growth or lure animals to a given location. Unlike human food, animal food is not subject to open-labeling laws; as a result, packaging claims are limited to purported results rather than quantified nutritional content. Manufacturer may also modify each batch depending on component prices; the present inventor has observed that the results promised are not always delivered.

Hunters are also interested in assuring that the animals they hunt will provide good nutritional quality when consumed. The present invention addresses the connection between what the animal consumes during its lifetime, and the nutritional value of such animal to the consumer.

Moreover, for game preserves, zoos, or private herds, population numbers and herd health is determined in part by the nutritional value of the food to which the ungulates have access. Fawns and mothers will be more robust, and, as a result, herd population accelerates at a faster rate than if under nutritional stress. In this setting, the quantity of feed distributed is not a mere bag or two: it is a year-round investment that must be reliable in nutritive quality and resist degradation in normal environmental conditions.

Lastly, nutritious food serves the traditional goals of antler size maximization, and attracting individual animals to the food source. Animals who have access to good nutrition will naturally have increasingly larger antler sizes and will return to the site where they previously found nutritious food.

### SUMMARY OF THE INVENTION

In general terms, this invention therefore provides deer food useful to positively influence the health of the animal who receives the food.

In particular, there is provided deer food having species-specific balanced nutritional formula, preferably, a health-promoting formula comprising carbohydrates, protein, fiber, vitamins and minerals.

The present invention further provides a feed that limits the chance of rumen acidosis and other problems associated with the particular digestive anatomy of deer.

The present invention further comprises optimized ratios of the components useful within the formulation, thereby maximizing the value to cost.

The present invention also provides methods of administering the present formulations, including timing and placement of the formulations.

The present invention also provides methods to make the present formulations.

These and other features and advantages of this invention will become more apparent to those skilled in the art from the detailed description of a preferred embodiment.

Definitions

“Whole wheat” includes that what is commonly understood as whole wheat, and also what is referred to in the milling industry as “middlings,” a fraction that is mostly bran (with germ) and some remanant flour. Any grade middlings is included in the definition of “whole wheat.”

### DETAILED DESCRIPTION

The present invention provides a deer food comprising: 10 to 60% protein, and at least 1% antler-promoting mineral source. Preferably, there is provided deer foods which comprise 18 to 45% protein, and at least 2% antler-promoting mineral source. Such foods which further comprises at least 5% fiber are most preferred, along with those which comprise approximately 7% to 15% fiber.

In one embodiment there is provided a deer food which comprises approximately 16 to 19% protein, approximately 10 to 12% fiber, and approximately 1 to 3% antler-promoting mineral source, wherein said antler-promoting mineral source is calcium. In another embodiment, there is provided a deer food which comprises approximately 24 to 27% protein, approximately 6 to 8% fiber, and approximately 1 to 3% antler-promoting mineral source, wherein said antler-promoting mineral source is calcium

Also provided is a deer food which comprises 15 to 25% corn, 30 to 35% wheat middlings, 15 to 20% soybean meal, and 10 to 20% grain hulls, 2 to 3% calcium carbonate, and 0.25 to 1% monocalcium phosphate. Also provided is a deer food which comprises 10 to 20% wheat middlings, 20 to 30% rice bran with germ, 2 to 7% grain hulls, 40 to 45% soybean meal, 3 to 5% calcium carbonate, and 1.75 to 2.5% monocalcium phosphate.

Any of the previously-described deer foods may optionally further comprise an ingredient selected from the group consisting essentially of: persimmon flavor, sweeteners, vitamins and minerals.

Preferred are those feeds wherein a combination of whole wheat, corn and soybean provides the majority of the nutrients. In particular, there is provided a feed comprising 25 to 40% ground wheat middlings, 15 to 25% ground corn, 20 to 35% soybean meal. Such a feed that further comprises 5 to 15% grain hulls is more preferred. In addition, there is provided a feed comprising 35 to 45% soybean meal, 10 to 20% wheat, 20 to 30% rice bran with germ.

Also provided are methods to feed deer, comprising placing a deer food of the present invention in an area that is frequented by deer.

Further, there is provided methods to make a deer food, comprising compressing into a pellet a meal of said protein, fiber and antler-promoting mineral source. Methods to further treat such pellets so as to become water-resistant are also provided.

Additionally, such feeds that further comprise antler-enhancing vitamins and minerals is preferred, particularly those that comprise calcium, zinc, salt, vitamin A, vitamin E, and vitamin D. Such compositions which further comprise sweeteners, especially molasses and cane sugar, and persimmon flavors are most preferred. In one preferred embodiment, minor amounts of oil is added.

Carbohydrate Source.

Carbohydrates useful in the present invention include any useful in the art that would accomplish the intended goal; which is, to provide a health-enhancing deer food. Any whole grain is useful as the carbohydrate source, alone or in combination with other grains. In the present invention, a combination of wheat “middlings” and whole corn is useful in one preferred embodiment, at approximately 50 to 55%, with the corn accounting for 15 to 25% of the mixture. In another embodiment, wheat middlings provide the carbohydrate source, at approximately 10 to 15% of the composition. By “whole” grain, it is intended to mean any grind (or no grind) of the whole grain. In other words, “whole” is not intended to mean “ground.” For instance, a whole wheat grain may be steel cut, rolled, ground, microground, or a combination thereof. Preferably, the grains are ground so as to be amenable to mixing with other ingredients and forming into a pellet, kibble or like piece. Moreover, although grains are known to those in the art as a good carbohydrate source, those in the art also recognize that grains naturally further comprise protein, fiber, water, vitamins, minerals and other nutrients. As used in the present invention, “carbohydrate source” is not intended to mean that the ingredient is solely, or purified, carbohydrate. “Carbohydrate source” is intended to mean that which is understood in the art: that the particular component contributes carbohydrates to the formula.

Preferred carbohydrate sources for use in the present invention include whole grains, including: wheat; corn; rice; barley; amaranth; brown rice; bulgur wheat; millet; oats; quinoa; rye; spelt; and wild rice.

Protein Source.

Protein sources include those that are generally-known in the art, including from animal flesh (including animals commonly eaten by humans, such as mammals and marine animals, and those less commonly eaten by humans, such as insects) or from plants. The protein source of the present invention is preferably from plant sources. Legumes, seeds, or protein components from plants are within the scope of the present invention. The more preferred protein source is soybean, including whole soybean, ground soybean, cooked soybean, paste soybean, soybean meal, etc. Soybean meal is the most preferred protein source for use in the present invention. In a preferred embodiment, the protein source is a combination of soybean meal and alfalfa meal, at 15 to 30% of the composition. In another preferred embodiment, the protein source is soybean meal at approximately 40 to 50% of the composition.

Fiber Source.

The present invention also incorporates a fiber source. Preferably, the fiber source is 10 to 35% of the food. Any fiber source, such as bran, hulls, etc. is useful in the present invention. In one embodiment, approximately 15% of the food is a fiber source, preferably a combination of soybean hulls and rice hulls. In another embodiment, approximately 30% of the food is fiber source, preferably a combination of rice bran and hulls.

Antler-Enhancing Minerals.

The present invention also includes antler-enhancing minerals as part of the formulations. Sources of calcium, including calcium carbonate, monocalcium phosphate, are preferred. Vitamins such as vitamin E, vitamin A and vitamin D are also useful in the present invention. In one preferred embodiment, a combination of calcium carbonate and monocalcium phosphate provide the antler-enhancing minerals, at 2 to 5%. In another preferred embodiment, calcium carbonate and monocalcium phosphate provide the antler-enhancing minerals, at 5 to 8% of the composition.

Optional components of the present invention include fiber, flavorants, colorants, sweeteners, and odor-enhancing or producing ingredients. For instance, hulls or bran are useful to provide fiber, preferably soybean and rice hulls. Dry persimmon flavor is a preferred flavorant. The sweeteners can comprise one or more monosaccharides or disaccharides. Examples include sugar, sucrose, invert sugar, dextrose, lactose, honey, malt syrup, malt syrup solids, maltose, fructose, granular fructose, maple syrup, rice syrup, rice syrup solids, sorghum syrup, refiners syrup, corn syrup, corn syrup solids, high fructose corn syrup, molasses, or combinations thereof. In addition, artificial sweeteners can be used such as acesulfame K, aspartame, sucralose, d-tagatose, and combinations thereof. Molasses (cane and/or dried) is a preferred sweetener in the present invention.

Preferred compositions of the present invention comprise 18 to 26% protein, 7 to 11.5% fiber, and a calcium to phosphate ratio of 1.5:1 to 2.1:1.

Nutrient content, for the purposes of the present claims, shall be that which is completed according to generally-recognized techniques, by Archer Daniels Midland (http://www.adm.com).

Mildew and Water-Resistance Ingredients. The present invention comprises ingredients that resist mildew and water absorption, while also being palatable to deer. Since deer are particularly sensitive to odors, these ingredients were carefully selected. For mildew resistance, calcium proprionate was added, at the minimal necessary to accomplish the desired effect. For water resistance, petrolatum was added, also at the minimal necessary to accomplish the desired effect. These ingredients are optional. Since deer accept these ingredients as part of the formula, and since rain and snow is inevitable for outdoor applications, it is preferred to include them.

The present invention comprises a plurality of relatively dry components. While it is easier to ship and handle dry components, it is not necessary that the present invention be relatively dry. Indeed, in field conditions, the formula may absorb water from the environment. The ratios of components, therefore, are approximate, fluctuations depending on a variety of external influences. The present invention has been identified over the course of years, and through many field variables, quantification and observation. All percentages herein are communicated as a weight percent of total.

### EXAMPLES

### Example I

### Deer Meal #1 Preparation

The following ingredients were blended together to form a meal. 34% wheat middlings, 20% ground corn, 18% high protein soybean meal, 10% soybean hulls, 9% dehydrated alfalfa meal (17%), 5% rice hulls, 2.5% calcium carbonate, 0.75% salt, 0.6 monocalcium phosphate, along with minimal vitamin A, trace minerals, vitamin E, dry persimmon flavor, sweetener, and vitamin D.

The nutrient analysis for deer meal #1 was: 18% protein, 11% fiber, ratio of calcium carbonate to calcium phosphate 2:1.

### Example 2

### Deer Meal #2 Preparation

The following ingredients were blended to form a dry meal. 42% high protein soybean meal, 25% rice bran with germ, 15% what middlings, 5% rice hulls, 4% calcium carbonate, 3% salt, 2.4% monocalcium phosphate, along with minimal molasses, soybean oil, trace minerals, dry persimmon flavor, vitamin D3, sweetener, and vitamin A.

The nutrient analysis was: 26% protein, 7% fiber, calcium carbonate to calcium phosphate ratio 1.6.

### Example 3

### Pellet Preparation

Meal of Example 1 or Example 2 is pressed into pellets using a standard pellet mill. Pellets of example 3 are then treated so as to become mildew- and water-resistant by blending minor amounts of calcium proprionate and petrolatum.

### Example 4

### Feeding Protocol #1 and Observations

On private land in Kansas, over the course of five years, the inventive feeds' effects on herd health were determined. Pellets made from Meal #1 and Meal #2, made according to Examples 3 and 4, were placed in a variety of gravity feeders, in several batches, intermittently over the course of five years. Every attempt was made to fill feeders as soon as they were emptied. The gravity feeders were placed in game trails, although the exact position was not essential. Piles of meal, which was not pelleted, were also placed in places likely to be frequented by deer. During the five years, 200-400 pound batches of feed, including meal and/or pellets, were exposed to all possible environmental conditions. Deer found each location in very short time, as short as one day. The feed was consumed within weeks of placing in the feeders. It is estimated that each deer consumed approximately 0.5 to 1 pound of feed per day.

Deer were seen on several occasions in the locality of the feeder prior to and after these pellets were fed. The health of the deer in the location of the feeders increased over the course of the five years. Body weights increased, fawn mortality decreased, and antler size increased.

### Example 5

### Feeding Protocol #2 and Observations

In various locations in the United States, deer were offered three types of deer feed. One feed was the feed of the present invention. The landowners did not know the formula or source of any of the feeds, and did not favor any one feed over the other when placing the feed on their land for this experiment. The feed of the present invention was fully consumed prior full consumption of the other two feeds. The deer favored the feed of the present invention.

The foregoing invention has been described in accordance with the relevant legal standards, thus the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

We claim:

1. A deer food comprising: 10 to 60% protein, and at least 1% antler-promoting mineral source.

2. A deer food of claim 1, which comprises 18 to 45% protein, and at least 2% antler-promoting mineral source.

3. A deer food of claim 1, which further comprises at least 5% fiber.

4. A deer food of claim 2, which further comprises 7% to 15% fiber.

5. A deer food of claim 2, which comprises approximately 16 to 19% protein, approximately 10 to 12% fiber, and approximately 1 to 3% antler-promoting mineral source, wherein said antler-promoting mineral source is calcium.

6. A deer food of claim 2, which comprises approximately 24 to 27% protein, approximately 6 to 8% fiber, and approximately 1 to 3% antler-promoting mineral source, wherein said antler-promoting mineral source is calcium.

7. A deer food of claim 1, which comprises 15 to 25% corn, 30 to 35% wheat middlings, 15 to 20% soybean meal, and 10 to 20% grain hulls, 2 to 3% calcium carbonate, and 0.25 to 1% monocalcium phosphate.

8. A deer food of claim 1, which comprises 10 to 20% wheat middlings, 20 to 30% rice bran with germ, 2 to 7% grain hulls, 40 to 45% soybean meal, 3 to 5% calcium carbonate, and 1.75 to 2.5% monocalcium phosphate.

9. A deer food of claim 3, which further comprises an ingredient selected from the group consisting essentially of: persimmon flavor, sweetener, molasses, soybean oil, vitamin A, vitamin D, salt, trace minerals, vitamin E.

10. A deer food of claim 5, which further comprises an ingredient selected from the group consisting essentially of: persimmon flavor, sweetener, molasses, soybean oil, vitamin A, vitamin D, salt, trace minerals, vitamin E.

11. A deer food of claim 6, which further comprises an ingredient selected from the group consisting essentially of: persimmon flavor, sweetener, molasses, soybean oil, vitamin A, vitamin D, salt, trace minerals, vitamin E.

12. A method to feed deer, comprising placing a deer food of claim 3 in an area that is frequented by deer.

13. A method to feed deer, comprising placing a deer food of claim 5 in an area that is frequented by deer.

14. A method to feed deer, comprising placing a deer food of claim 6 in an area that is frequented by deer.

15. A method to make a deer food of claim 3, comprising compressing into a pellet a meal of said protein, fiber and antler-promoting mineral source.

16. A method to make a deer food of claim 5, comprising compressing into a pellet a meal of said protein, fiber and antler-promoting mineral source.

17. A method to make a deer food of claim 6, comprising compressing into a pellet a meal of said protein, fiber and antler-promoting mineral source.

18. A deer food of claim 2, which further comprises calcium proprionate.

19. A deer food of claim 2, which further comprises petrolatum.

20. A deer food of claim 2, which further comprises calcium proprionate and petrolatum.
